(19) United States
(12) Patent Application Publication
(10) Pub. No.: US 2011/0066467 A1
(43) Pub. Date: Mar. 17, 2011

(54) SCHEDULING MULTIPLE PROJECTS USING PHASE WORK-IN-PROCESS AND RESOURCE CONSTRAINTS

(75) Inventors: Ajai Kapoor, San Jose, CA (US); Subbarao Nimmakayala, Livermore, CA (US); Puneet Murgai, Sunnyvale, CA (US); Xiangting Yuan, Pleasanton, CA (US); Ravi Shankar, San Jose, CA (US)

(73) Assignee: REALIZATION TECHNOLOGIES, INC., San Jose, CA (US)

(21) Appl. No.: 12/609,986

(22) Filed: Oct. 30, 2009

Related U.S. Application Data
(60) Provisional application No. 61/242,950, filed on Sep. 16, 2009.

(51) Int. Cl. G06Q 10/00

(52) U.S. Cl. 705/8

(57) ABSTRACT

Some embodiments provide a system for scheduling multiple projects. During operation, the system can receive a set of projects. Each project can be associated with a due date, and can include a group of tasks whose interdependencies are representable using a task dependency network. Next, the system can associate at least some tasks in some of the projects with a phase. The system can then determine project start times and project end times for at least some projects in the set of projects so that the aggregate weight of the projects that are in the phase at any given time is less than or equal to a work-in-process (WIP) limit associated with the phase. The system can also impose resource usage constraints. Further, the system can enable the user to evaluate the impact on the project schedules if the duration of one or more phases is changed.

### RELATED APPLICATION

This application claims priority to U.S. Provisional Application Ser. No. 61/242,950, entitled “Virtual Drum Based Scheduling,” by Ajai Kapoor, Rao Nimmakayala, Puneet Murgai, Xianting Yuan, and Ravi Shankar, filed on 16 Sep. 2009, attorney docket number REAL09-0001P, the contents of which are herein incorporated by reference.

### BACKGROUND

1. Technical Field

The present disclosure generally relates to scheduling multiple projects. More specifically, the present disclosure relates to methods and apparatuses for scheduling multiple projects by using phase work-in-process limits as well as resource capacity limits.

2. Related Art

The ability to successfully complete projects on time is critical for any organization's success. Not surprisingly, organizations spend large amounts of resources to ensure that projects are properly planned and executed. Unfortunately, despite all of the resources spent on project planning and execution, very few projects complete on time and are within budget.

In theory, properly planned projects should complete on time. However, in reality, project plans are inherently uncertain because the future is unpredictable. Many unforeseen events may occur during the execution of the project which may cause the project plan to slip. For example, requirements may change, equipment may fail, vendors may not deliver on time, work may materialize more slowly than expected, approvals may not be granted on time, priorities may change, etc. Due to such unforeseen events, work in projects is constantly interrupted waiting for completion of other activities, resources, experts, decisions by managers, materials, approvals, etc. Thus projects rarely follow the initial project plan, and are rarely completed on time, and lot of time and resources are wasted.

While some wastage is unavoidable due to inherent uncertainties, a lot of wastage usually occurs because of poor synchronization of priorities across projects and departments. Specifically, to handle uncertainties, projects are typically started as soon as they can which can cause too many projects and/or work streams to be in execution. As a result, resources (including experts and managers) have a large queue of work in front of them and priorities become unclear (e.g., it is unclear which task they should do next) and desynchronized (e.g., because resources prioritize tasks in their own way). Further, to finish tasks on time despite uncertainties, workers are asked to meet their estimates and the amounts of work completed by them are measured. These local measurements lead to working on easy but less important activities, not passing on work to next resource if finished early, or starting slow and finding uncertainties late causing other resources to be idle. Finally, not having a uniform prioritization system during execution for resources leads to resources to work on conflicting priorities.

Hence, it is generally desirable to enable organizations to schedule projects to overcome the above-described problems, and to increase the likelihood that the projects will complete on time and under budget.

### SUMMARY

Some embodiments of the present invention provide systems and techniques for scheduling multiple projects. Specifically, the systems and techniques can schedule multiple projects so that the work-in-process in one or more phases is within user-specified limits. Limiting the work-in-process in one or more phases can ensure that the projects are scheduled in a manner that does not overload resources, ensures smaller queues of work for resources allowing them to have synchronized priorities, and also makes extra resources available to be allocated to tasks when needed to absorb the uncertainties. In addition to limiting phase level work-in-process, some embodiments can also explicitly schedule the load on the resource such that the load is within its capacity limit.

During operation, the system can receive a set of projects. The term “receive” is used broadly in this disclosure to generally mean that the system can now access certain information. For example, the system may receive the set of projects when a user provides a file name to the system which contains a description of the set of projects. Alternatively, the system may receive the set of projects when the system receives a sequence of network packets which describe the set of projects.

Each project can include a group of tasks whose interdependencies are representable using a task dependency network. Further, each project can be associated with a due date. Next, the system can associate at least some tasks in some of the projects with a phase. The system can then determine project start times and project end times for at least some projects in the set of projects so that the aggregate weight of the projects that are in the phase at any given time is less than or equal to a work-in-process limit associated with the phase.

Note that the set of projects can include ongoing projects and projects that have not yet started. The project start times and the project end times are determined for projects that have not yet started. However, for ongoing projects, the system can treat the project start times and project end times (which are already known) as fixed. Note that the ongoing projects are used for computing the aggregate weight of the projects that are in the phase at any given time.

In some embodiments, the system can schedule a project so that the project's end time coincides with the project's due date. Next, the system can determine a phase start time and a phase end time for the phase in the project based at least on the project's due date. In particular, the system can align the project's task dependency network's end time with the project's due date. Next, the system can set the phase end time to be equal to the latest task end time over all tasks in the project that are associated with the phase, and set the phase start time to be equal to the earliest task start time over all tasks in the project that are associated with the phase. The system can then check if the aggregate weight of the projects in the phase is greater than the work-in-process limit. If so, the system can reschedule the project to a different time so that the work-in-process limit is not violated. In particular, the system can reschedule the project so that the project's end time is either earlier or later than the project's due date.

In some embodiments, after determining the phase start time and the phase end time, the system adds a capacity buffer to the phase by moving the phase end time to a later time. In other embodiments, the tasks in the phase include buffers, and hence, the system does not add a capacity buffer to the phase.

Note that, when the system reschedules a project to a different time, the system may move all phases of the project together so that the project's cycle time remains unchanged. Alternatively, the system may move different phases of the project by different amounts, thereby changing (e.g., increasing) the project's cycle time. Further, when the system reschedules a project, the system may notify a user that at least one project was rescheduled due to a violation of the work-in-process limit associated with the phase. The system may also provide information to the user about the phase(s) that caused the system to reschedule the project(s).

In some embodiments, each project's weight is set to one so that the aggregate weight of the projects that are in the phase is equal to the number of projects that are in the phase.

In some embodiments, to determine the project start times and project end times, the system can prioritize the set of projects, and schedule the set of projects in decreasing order of priority. Specifically, the system can prioritize the set of projects according to due dates so that an earlier due date is associated with a higher priority.

In some embodiments, the system enables the user to select which tasks are associated with a phase. Specifically, the system can present a task dependency network for a project to a user. Next, the system can receive input from the user which identifies a first group of tasks in the task dependency network that defines the phase's boundary. The system can then identify a second group of tasks such that each task in the second group of tasks lies on at least one path between two tasks in the first group of tasks. Next, the system can associate the first group of tasks and the second group of tasks with the phase.

In some embodiments, all tasks in all of the projects are associated with the phase. In these embodiments, the system essentially schedules the projects so that only a certain number of projects are active at any given time.

Some embodiments of the present invention enable the user to ask “what if” questions to determine the impact of changing the duration of a phase. Specifically, the system can present project start times and the project end times for at least some projects to a user. Next, the system can receive, from the user, new phase durations for one or more phases in one or more projects which are different from the phase durations that were used for determining the project start times and the project end times. The system can then use the new phase durations to determine new project start times and new project end times so that the aggregate weight of the projects that are in the phase at any given time is less than or equal to a work-in-process limit associated with the phase. Finally, the system can present the new project start times and the new project end times to the user, thereby enabling the user to determine the impact on the project schedule if the duration of one or more phases is changed.

In some embodiments, the system can impose aggregate resource usage limits in addition to imposing WIP limits. Specifically, the system can add one or more resource usage amounts to one or more time buckets based at least on when a resource is expected to be used by a project. Next, the system can check if a time bucket's aggregate resource usage across all projects exceeds a usage limit associated with the resource. If so, the system can reschedule the project to a different time to satisfy the resource usage limit.

### BRIEF DESCRIPTION OF THE FIGURES

FIG. 1 illustrates multiple projects in accordance with an embodiment of the present invention.

FIG. 2 illustrates how tasks can be associated with phases in accordance with an embodiment of the present invention.

FIG. 3 illustrates how a project can be represented using phases in accordance with an embodiment of the present invention.

FIG. 4 presents a flow chart which illustrates a process for associating a phase with a set of tasks in accordance with an embodiment of the present invention.

FIGS. 5A and 5B illustrate how a phase can be associated with a set of tasks in accordance with an embodiment of the present invention.

FIG. 6 presents a flow chart that illustrates a process for scheduling multiple projects in accordance with an embodiment of the present invention.

FIG. 7 presents a flow chart that illustrates a process for determining a project start time and a project end time for a project in accordance with an embodiment of the present invention.

FIGS. 8A, 8B, and 8C illustrate how a project start time and a project end time can be determined in accordance with an embodiment of the present invention.

FIG. 9 illustrates how the system can impose resource usage constraints in accordance with an embodiment of the present invention.

FIG. 10 presents a flow chart which illustrates a process for enabling a user to test alternative scenarios in accordance with an embodiment of the present invention.

FIG. 11 illustrates a computer system in accordance with an embodiment of the present invention.

FIG. 12 illustrates an apparatus in accordance with an embodiment of the present invention.

### DETAILED DESCRIPTION

The following description is presented to enable any person skilled in the art to make and use the embodiments. Various modifications to the disclosed embodiments will be readily apparent to those skilled in the art, and the general principles defined herein are applicable to other embodiments and applications without departing from the spirit and scope of the present disclosure. Thus, the present invention is not limited to the embodiments shown, but is to be accorded the widest scope consistent with the principles and features disclosed herein.

The data structures and code described in this disclosure can be partially or fully stored on a computer-readable storage medium and/or a hardware module and/or hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The methods and processes described in this disclosure can be partially or fully embodied as code and/or data, so that when a computer system executes the code and/or data, the computer system performs the associated methods and processes. The methods and processes can also be partially or fully embodied in hardware modules or apparatuses, so that when the hardware modules or apparatuses are activated, they perform the associated methods and processes. Note that the methods and processes can be embodied using a combination of code, data, and hardware modules or apparatuses.

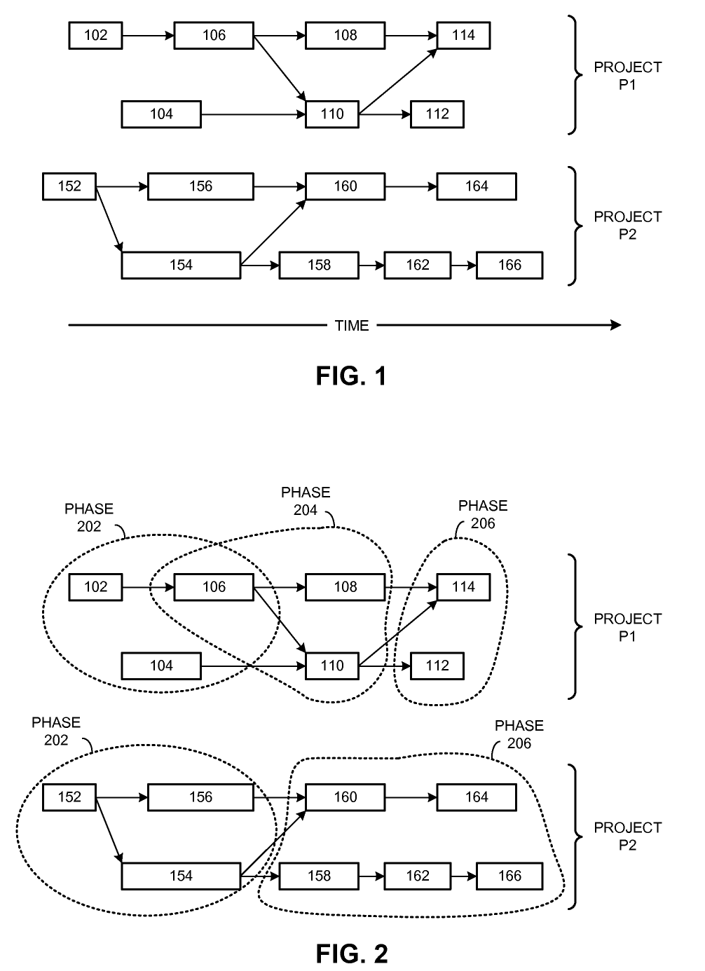

FIG. 1 illustrates multiple projects in accordance with an embodiment of the present invention.

A project can generally be defined as a temporally bounded endeavor which is designed to achieve specific goals and objectives. A project is usually associated with a due date, i.e., a date by which a project needs to be completed. In some cases, the project must be completed on the due date, i.e., completing the project before the due date is not allowed. In other cases, the due date is an “on or before” due date, i.e., the project is allowed to be completed on the due date or before the due date.

A project can be represented as a set of interdependent tasks. A task can generally be defined as a unit of work which needs to be performed within a specific time period. A task is usually associated with an owner, a set of resources that the task is expected to use, and a start time and an end time.

An organization typically needs to schedule multiple projects at any given time. For example, as shown in FIG. 1, an organization may have projects P1 and P2. Project P1 can include multiple tasks, such as tasks 102-114. Similarly, project P2 can also include multiple tasks, such as tasks 152-166. Note that the X-axis in FIG. 1 denotes time.

Each task in FIG. 1 is represented as a rectangle, where the left edge of the rectangle is associated with the task's start time, and the right edge of the rectangle is associated with the task's end time. The tasks can have interdependencies which can be represented using a task dependency network as shown in FIG. 1. A directed edge from task 102 to task 104 indicates that task 104 can be started only after task 102 has completed. Similarly, task 110 can be started only after tasks 104 and 106 have been completed because there are two directed edges from tasks 104 and 106 that are incident on task 110. Likewise, project P2's task dependency network shows that task 160 can be started only after tasks 156 and 154 have completed.

FIG. 2 illustrates how tasks can be associated with phases in accordance with an embodiment of the present invention.

In general, a phase can be an arbitrary collection of tasks, and a task can be associated with one or more phases. Phase 202 includes tasks 102, 104, and 106. In other words, tasks 102, 104, and 106 are associated with phase 202. Similarly, phase 204 includes tasks 106, 108, and 110, and phase 206 includes tasks 112 and 114. Note that, since the association between tasks and phases is arbitrary, two phases can share the same task. For example, phases 202 and 204 both include task 106.

Tasks from different projects can be associated with the same phase. For example, tasks 102, 104, and 106 in project P1, and tasks 152, 154, and 156 in project P2 are associated with phase 202.

Different projects may include different sets of phases. For example, project P1 includes phases 202, 204, and 206. However, project P2 includes phases 202 and 206, but does not include phase 204.

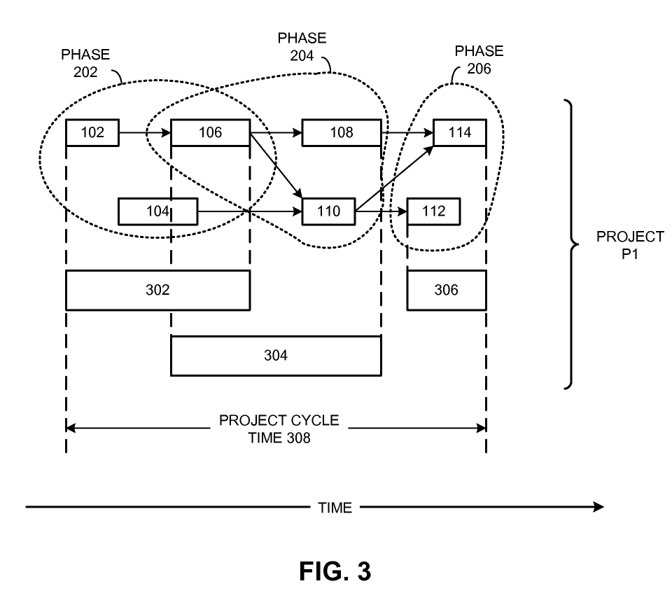

FIG. 3 illustrates how a project can be represented using phases in accordance with an embodiment of the present invention.

Once tasks have been associated with phases, a project can be represented in terms of phases. For example, project P1 can be represented as a collection of phases 202, 204, and 206. Each phase can be illustrated as a rectangle, where the left edge of the phase denotes the start time of the phase, and the right edge denotes the end time of the phase. For example, rectangles 302, 304, and 306 can be used to visually represent phases 202, 204, and 206, respectively. The system may also represent dependencies among phases using directed edges.

A project's cycle time is defined as the duration for which the project is active. Specifically, the project's cycle time is equal to the time interval between the earliest task start time and the latest task end time in the project. For example, as shown in FIG. 3, project cycle time 308 for project P1 is equal to the time interval from task 102's start time to task 114's end time.

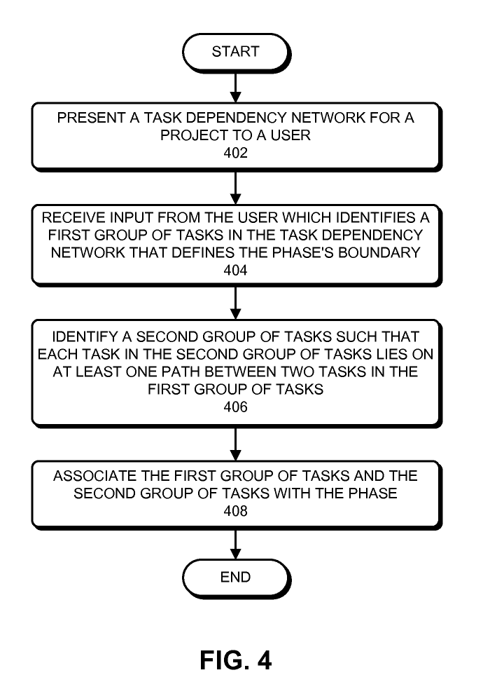

FIG. 4 presents a flow chart which illustrates a process for associating a phase with a set of tasks in accordance with an embodiment of the present invention.

The process can begin by presenting a task dependency network for a project to a user (block 402). Next, the system can receive input from the user which identifies a first group of tasks in the task dependency network that defines the phase's boundary (block 404). The system can then identify a second group of tasks such that each task in the second group of tasks lies on at least one path between two tasks in the first group of tasks (block 406). The system can then associate the first group of tasks and the second group of tasks with the phase (block 408). The process illustrated in FIG. 4 is for illustration purposes only. Specifically, the process illustrated in FIG. 4 is not intended to limit the present invention to the forms disclosed. For example, in a variation of the process, the user may explicitly select each task that the user wants to associate with a phase.

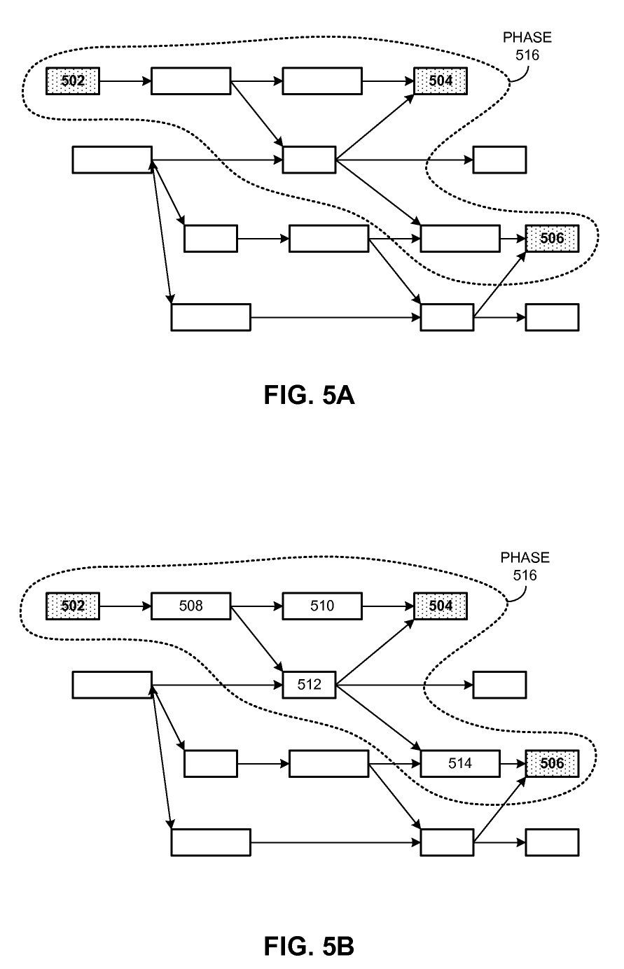

FIGS. 5A and 5B illustrate how a phase can be associated with a set of tasks in accordance with an embodiment of the present invention.

FIG. 5A illustrates a task dependency network for a project in which the user has selected a first group of tasks (tasks 502-506) which defines phase 516's boundary. FIG. 5B illustrates how the system can identify a second group of tasks (tasks 508-514) such that each task in the second group of tasks lies on at least one path between two tasks in the first group of tasks. For example, task 508, which is in the second group of tasks, lies on a path between tasks 502 and 504, which are in the first group of tasks. The system can then associate the first group of tasks and the second group of tasks with phase 516.

An organization typically includes multiple projects that share resources. Conventional scheduling techniques typically schedule projects so that no resource conflicts are present in the project plan. However, as mentioned above, project plans that are created by conventional scheduling techniques can easily be derailed by unforeseen events.

Some embodiments of the present invention schedule projects so that, at any given time, the weighted work-in-process (WIP) for a collection of phases is less than the user-specified limits for these phases. These embodiments are based at least on the following insight: if projects are scheduled by controlling the WIP for certain phases, the resulting project plan is relatively immune to unforeseen events that are bound to occur during execution.

The WIP for a phase can be defined as the number of projects that are currently in the phase. For example, as shown in FIG. 2, if projects P1 and P2 are simultaneously in phase 202, then the WIP for phase 202 will be equal to two. If projects are associated with weights, a weighted WIP for a phase can be computed by aggregating the weights of the projects that are in the phase. For example, if project P1 has a weight of two, and project P2 has a weight of three, then in the above example the weighted WIP for phase 202 will be equal to five. Note that the “non-weighted” WIP is equivalent to the weighted WIP when all projects are assigned a weight of one.

Specifically, in some embodiments of the present invention, the system can identify phases for which WIP limits are to be imposed. Next, the system can schedule projects so that at any given time the aggregate weight of the projects that are in a particular phase is less than or equal to the associated WIP limit. For example, suppose projects P1 and P2 have weights two and three, respectively, and the WIP limit for phase 202 is equal to four. Then, the system will schedule projects P1 and P2 so that only one of those projects is in phase 202 at any given time because if both projects are in phase 202 simultaneously, the weighted WIP for phase 202 will be equal to five, which violates the WIP limit.

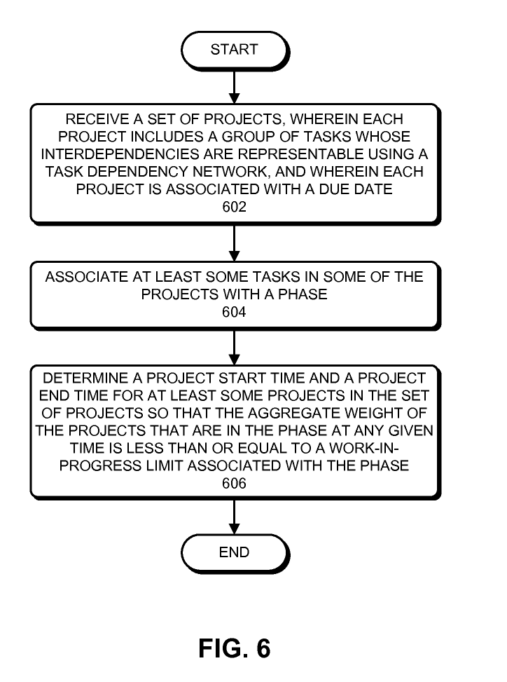

FIG. 6 presents a flow chart that illustrates a process for scheduling multiple projects in accordance with an embodiment of the present invention.

The process can begin by receiving a set of projects, wherein each project includes a group of tasks whose interdependencies are representable using a task dependency network, and wherein each project is associated with a due date (block 602). Note that the set of projects may include ongoing projects whose start and end dates are fixed because those dates have already been determined, and are not to be changed during the scheduling process. To compute the weighted WIP for a phase, the system considers all projects, i.e., both ongoing projects and projects that are currently being scheduled.

Next, the system can associate at least some tasks in some of the projects with a phase (block 604).

The system can then determine a project start time and a project end time for at least some projects in the set of projects so that the aggregate weight of the projects that are in the phase at any given time is less than or equal to a work-in-process limit associated with the phase (block 606).

Note that an interval tree data structure can be used to store time intervals, e.g., the time intervals associated with tasks, phases, and projects. An interval tree data structure allows one to efficiently find all intervals that overlap with any given interval or point. Further details of an interval tree data structure can be found in any standard text on computer algorithms. For example, details of an interval tree data structure can be found in Thomas H. Cormen, Charles E. Leiserson, Ronald L. Rivest, and Clifford Stein, Introduction to Algorithms, Second Edition, MIT Press and McGraw-Hill, 2001.

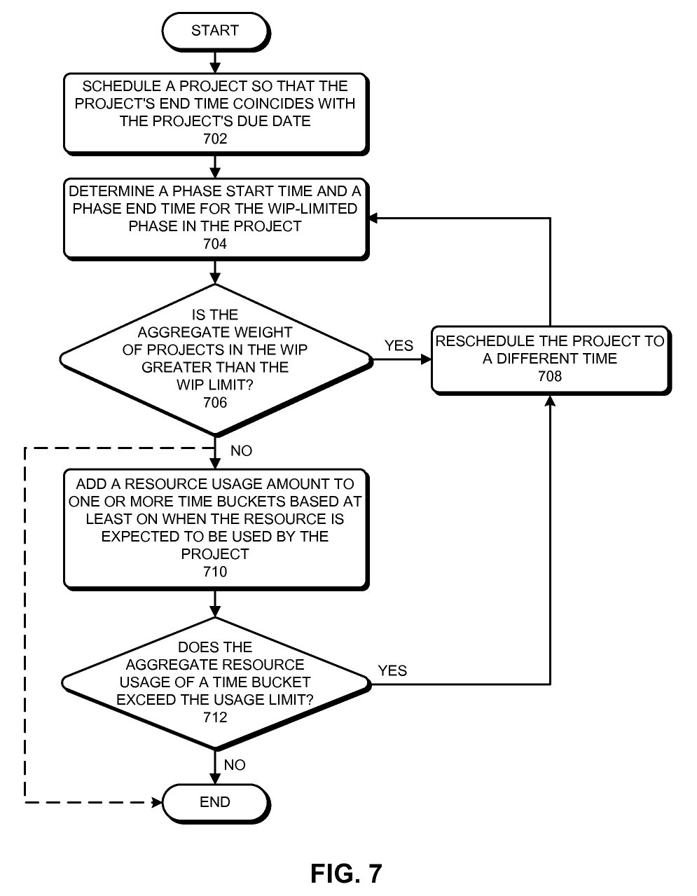

FIG. 7 presents a flow chart that illustrates a process for determining a project start time and a project end time for a project in accordance with an embodiment of the present invention.

The process can begin by scheduling a project so that the project's end time coincides with the project's due date (block 702).

Next, the system can determine a phase start time and a phase end time for a WIP-limited phase in the project based at least on the project's due date (block 704).

The system can then check if the aggregate weight of the projects in the phase is less than or equal to the WIP limit (block 706).

If the aggregate weight is greater than the WIP limit, the system can reschedule the project to a different time (block 708) so that the project's end time is different from the project's due date.

Specifically, the system can reschedule the project so that the project's end time is earlier or later than the first project's due date. Further, while rescheduling the project, the system can move all phases of the project together so that the first project's cycle time remains unchanged. Alternatively, the system can move the project's phases by different amounts, thereby changing the project's cycle time.

On the other hand, if the aggregate weight is less than or equal to the WIP limit, the process can terminate (shown as a dashed line in FIG. 7). Alternatively, if the aggregate weight is less than or equal to the WIP limit, the system can then check for compliance with resource usage limits.

Specifically, a user may identify one or more resources and associate usage limits with the resources. Further, the system can create a set of time buckets, i.e., short time intervals, to keep track of resource usage.

To check for compliance with the resource usage limits, the system can add one or more resource usage amounts to one or more time buckets based at least on when the resource is expected to be used by the project (block 710). Note that the resource usage limit and the phase WIP limit can be completely independent constraints. For example, the resource usage limit can be associated with a resource which is not used in the phase for which a phase WIP limit is being imposed.

Next, the system can check if the aggregate resource usage exceeds the usage limit associated with the resource (block 712). If no resource usage violation is detected, the process can terminate. On the other hand, if the system detects that the aggregate resource usage exceeds the usage limit, the system can reschedule the project to a different time (block 708) so that the project's end time is different from the project's due date.

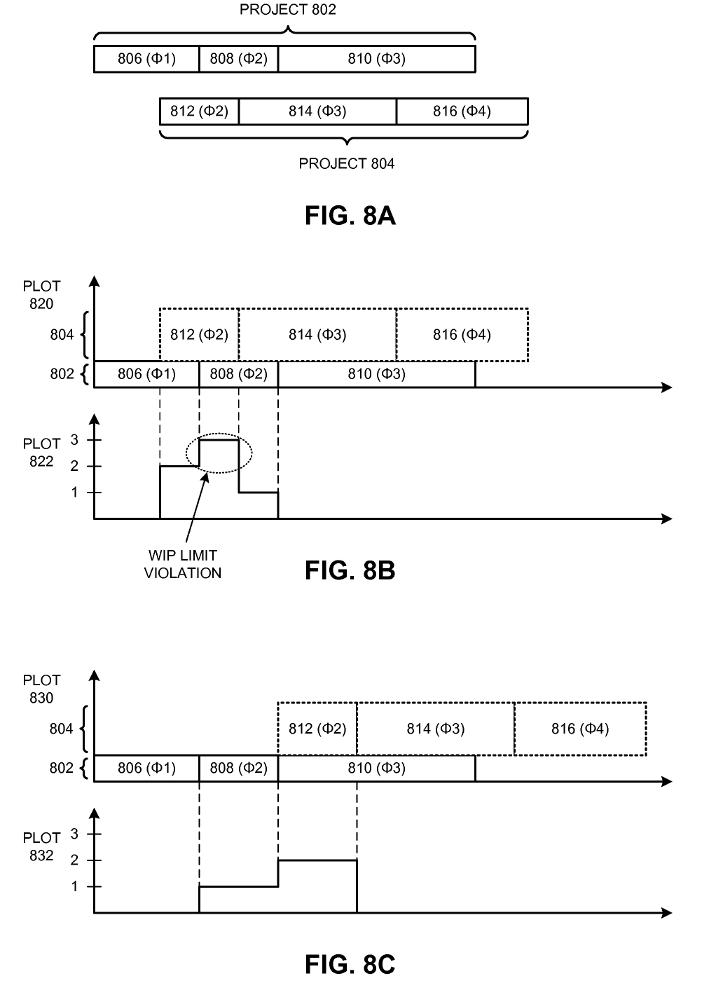

FIGS. 8A, 8B, and 8C illustrate how a project start time and a project end time can be determined in accordance with an embodiment of the present invention.

As shown in FIG. 8A, project 802 includes phases φ1, φ2, and φ3, which are represented by rectangles 806, 808, and 810, respectively. Project 804 includes phases φ2, φ3, and φ4, which are represented by rectangles 812, 814, and 816, respectively. The left edge and the right edge of each rectangle correspond to the start time and the end time, respectively, of the associated phase. Further, suppose phase φ2 has a weighted WIP limit of two, and projects 802 and 804 are associated with weights one and two, respectively.

In some embodiments, the system can prioritize the set of projects and schedule the set of projects in decreasing order of priority. Specifically, the set of projects can be ordered according to their due dates so that a project with an earlier due date is associated with a higher priority. For example, since project 802's due date is before project 804's due date, the system can schedule project 802 before scheduling project 804.

As shown in plot 820 in FIG. 8B, project 802 can be scheduled so that project 802's end time coincides with project 802's due date. Since there are no WIP limit violations at this point, project 802's start time and end time have been determined. Next, the system can try to schedule project 804 so that project 804's end time coincides with project 804's due date. Plot 822 shows the variation in the weighted WIP if project 804 is scheduled as shown in plot 820. Note that the weighted WIP exceeds the WIP limit when both projects 802 and 804 are simultaneously in phase φ2. Hence, the system reschedules project 804 so that project 804's end time is different from the project 804's due date, and in doing so, satisfies the WIP limit constraint.

The system can iteratively select different times (e.g., by incrementing or decrementing the project end time by a small interval) for scheduling the project until the system identifies a time where no WIP limit violations are present. For example, the system may reschedule project 804 as shown in plot 830 in FIG. 8C. Plot 832 shows the variation in the weighted WIP if project 804 is scheduled as shown in plot 830. Note that there are no WIP limit violations. Note that the X-axis in plots 820, 822, 830, and 832 represents time. The Y-axis in plots 820 and 830 represents projects, whereas the Y-axis in plots 822 and 832 represents the aggregate WIP in phase φ2.

It will be apparent to practitioners that the system can use this scheduling technique if multiple phases have WIP limits. Specifically, if multiple phases have WIP limits, the system can schedule a project at a candidate time, and check for WIP limit violations for each of the multiple phases. If a violation is detected, the system can reschedule the project to a different time, and continue this process until the system determines a time which does not cause any WIP limit violations.

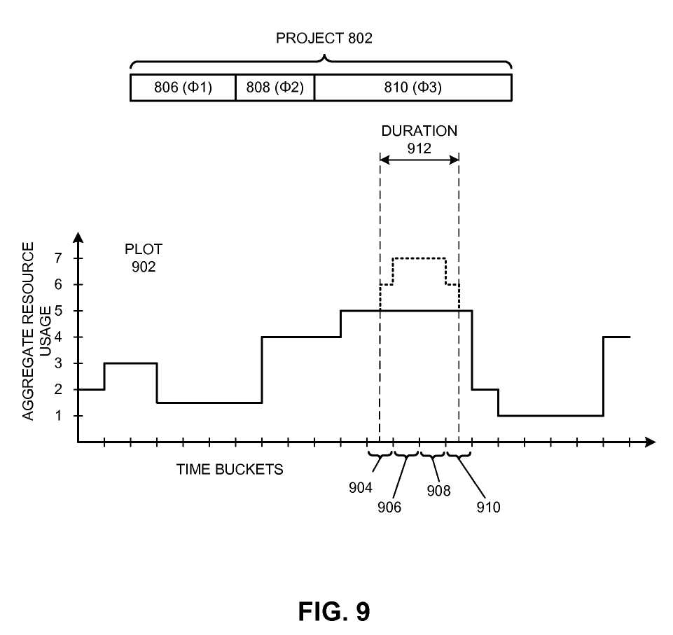

FIG. 9 illustrates how the system can impose resource usage constraints in accordance with an embodiment of the present invention.

In addition to imposing WIP limit constraints for one or more phases, the system can also impose resource usage constraints for one or more resources. The X-axis in plot 902 represents time buckets, such as time buckets 904-910. A time bucket is an interval of time which is used for keeping track of resource usage. For example, a time bucket can be one day long if it is desired to keep track of resource usage at the granularity of one day. The Y-axis in plot 902 represents the aggregate resource usage for a particular resource.

The system can add one or more resource usage amounts to one or more time buckets. Each project is expected to use one or more resources for certain durations while the project is active. Specifically, each project has tasks which are expected to use resources while the tasks are being performed. The task dependency network (which includes the task start and end times) can be used to determine when a project is expected to use a particular resource.

In one embodiment, the system spreads the resource usage of a resource uniformly over a set of time buckets which corresponds to when the resource is expected to be used by the project. The resource usage amount R(T) that is added to time bucket T can be expressed as:

$$R ( T ) = \frac{r}{d} \cdot f ( T , D ) , \qquad ( 1 )$$

where D is the resource usage interval (e.g., expressed as a start time and an end time), f(T, D) is the length of overlap between time bucket T and duration D, r is the total resource usage, and d is the length of time interval D.

As shown in FIG. 9, suppose phase φ3 in project 802 is expected to use six units of a resource for duration 912. Length of duration 912 is equal to three time buckets. Duration 912 spans time buckets 904-910 such that duration 912 starts halfway through time bucket 904, and ends halfway through time bucket 910. Since duration 912 is equal to three time buckets, the resource usage amount per time bucket is equal to two. Hence, the system will add two resource usage units to each time bucket that is fully used, and a fractional amount if the time bucket is only partially used.

Specifically, in Equation (1) shown above, r=6 and d=3, and f(T, D) is equal to 0.5, 1, 1, and 0.5, for time buckets 904, 906, 908, and 910, respectively. Hence, the system will add a resource usage amount of 1, 2, 2, and 1 to time buckets 904, 906, 908, and 910, respectively. The dotted line in FIG. 9 illustrates the effect of adding these resource usage amounts to the time buckets. If the resource usage limit were equal to five, then scheduling project 802 at this location would violate the resource usage limit constraint. On the other hand, if the resource usage limit were equal to seven, then project 802 can be successfully scheduled at this location without violating the resource usage limits.

In some embodiments, the per time-bucket resource usage, and the expected duration for the resource usage may be provided to the system. Note that, in this embodiment, the system does not calculate the per time bucket resource usage by dividing the total resource usage by the resource usage duration (in units of time buckets). For example, in the above example, the system would be provided with the two units per time-bucket resource usage, which the system can then use to add the appropriate resource usage amounts to the time buckets.

Once projects have been scheduled, the system may present the start and end times for the projects to the user. To satisfy the WIP limits and/or resource usage limits, some projects may need to be scheduled so that their end time is after their due date. The user may want to explore alternative scenarios in which these projects are scheduled so that they end on time. Some embodiments of the present invention allow the user to ask “what if” questions so that the user can explore these alternative scenarios and take appropriate corrective actions.

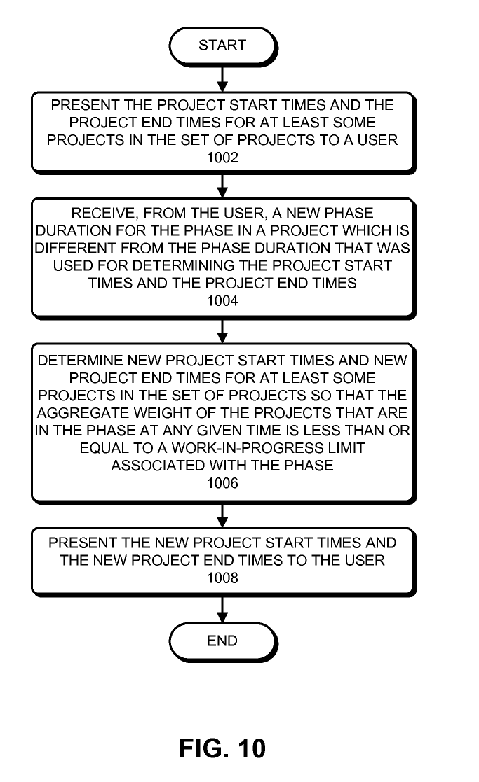

FIG. 10 presents a flow chart which illustrates a process for enabling a user to test alternative scenarios in accordance with an embodiment of the present invention.

The process can begin by presenting the project start times and the project end times for at least some projects in the set of projects to a user (block 1002).

Next, the system can receive, from the user, a new phase duration for the phase in a project which is different from the phase duration that was used for determining the project start times and the project end times (block 1004).

The system can then determine new project start times and new project end times for at least some projects in the set of projects so that the aggregate weight of the projects that are in the phase at any given time is less than or equal to a work-in-process limit associated with the phase (block 1006).

Next, the system can present the new project start times and the new project end times to the user (block 1008), thereby enabling the user to determine the impact on the project schedules if the duration of one or more phases is changed.

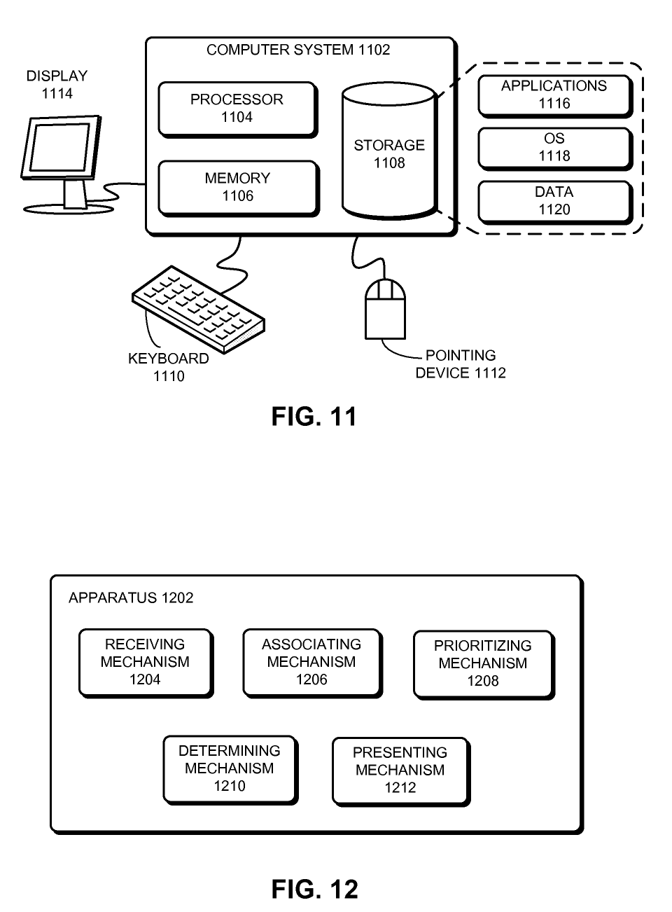

FIG. 11 illustrates a computer system in accordance with an embodiment of the present invention.

A computer system can generally be any system that can perform computations. Specifically, a computer system can be a microprocessor, a network processor, a portable computing device, a personal organizer, a device controller, or a computational engine within an appliance, or any other computing system now known or later developed. Computer system 1102 comprises processor 1104, memory 1106, and storage 1108. Computer system 1102 can be coupled with display 1114, keyboard 1110, and pointing device 1112. Storage 1108 can generally be any device that can store data. Specifically, a storage device can be a magnetic, an optical, or a magneto-optical storage device, or it can be based on flash memory and/or battery-backed up memory. Storage 1108 can store application 1116, operating system 1118, and data 1120.

Application 1116 can include instructions that when executed by computer 1102 cause computer 1102 to perform one or more processes described in this disclosure. Data 1120 can include project names and start and end times, task names and start and end times, task dependency information, and/or any other information that may be required for scheduling multiple projects.

FIG. 12 illustrates an apparatus in accordance with an embodiment of the present invention.

Apparatus 1202 can comprise a number of mechanisms which may communicate with one another via a wired or wireless communication channel. Apparatus 1202 may be realized using one or more integrated circuits. Apparatus 1202 may be integrated with a computer system, or it may be realized as a separate device which is capable of communicating with other computer systems and/or devices. Specifically, apparatus 1202 can comprise receiving mechanism 1204, associating mechanism 1206, prioritizing mechanism 1208, determining mechanism 1210, and presenting mechanism 1212.

In some embodiments, receiving mechanism 1204 can be configured to receive a set of projects, wherein each project includes a group of tasks whose interdependencies are representable using a task dependency network, and wherein each project is associated with a due date. Associating mechanism 1206 may be configured to associate at least some tasks in some of the projects with a phase. Prioritizing mechanism 1208 may be configured to prioritize the set of projects. Determining mechanism 1210 may be configured to determine project start times and project end times for at least some projects in the set of projects so that the aggregate weight of the projects that are in the phase at any given time is less than or equal to a work-in-process limit associated with the phase. Presenting mechanism 1212 may be configured to present the project start times and the project end times for at least some projects in the set of projects to a user.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-executed method for scheduling multiple projects, the method comprising:
receiving a set of projects, wherein each project includes a group of tasks whose interdependencies are representable using a task dependency network, and wherein each project is associated with a due date;
associating at least some tasks in some of the projects with a phase; and
determining project start times and project end times for at least some projects in the set of projects so that the aggregate weight of the projects that are in the phase at any given time is less than or equal to a work-in-process limit associated with the phase.

2. The method of claim 1, wherein each project's weight is set to one so that the aggregate weight of the projects that are in the phase is equal to the number of projects that are in the phase.

3. The method of claim 1, wherein determining the project start times and the project end times for at least some projects in the set of projects includes:
prioritizing the set of projects; and
scheduling the set of projects in decreasing order of priority.

4. The method of claim 3, wherein prioritizing the set of projects involves ordering the set of projects according to due dates so that an earlier due date is associated with a higher priority.

5. The method of claim 1, wherein determining the project start times and the project end times for at least some projects in the set of projects includes:
scheduling a first project so that the first project's end time coincides with the first project's due date;
determining a phase start time and a phase end time for the phase in the first project based at least on the first project's due date; and
in response to detecting that the aggregate weight of the projects in the phase is greater than the work-in-process limit, rescheduling the first project so that the first project's end time is different from the first project's due date.

6. The method of claim 5, wherein rescheduling the first project so that the first project's end time is different from the first project's due date includes scheduling the first project so that the first project's end time is later than the first project's due date.

7. The method of claim 5, wherein rescheduling the first project so that the first project's end time is different from the first project's due date includes scheduling the first project so that the first project's end time is earlier than the first project's due date.

8. The method of claim 5, wherein rescheduling the first project so that the first project's end time is different from the first project's due date includes moving all phases of the first project together so that the first project's cycle time remains unchanged.

9. The method of claim 5, wherein rescheduling the first project so that the first project's end time is different from the first project's due date includes moving the first project's phases by different amounts, thereby changing the first project's cycle time.

10. The method of claim 5, wherein the method further includes:
in response to detecting that the aggregate weight of the projects in the phase is greater than the work-in-process limit, notifying a user that at least one project was rescheduled due to a violation of the work-in-process limit associated with the phase.

11. The method of claim 5, wherein determining the project start times and the project end times for at least some projects in the set of projects further includes:
adding one or more resource usage amounts to one or more time buckets based at least on when the resource is expected to be used by the first project; and
in response to detecting that a time bucket's aggregate resource usage exceeds a usage limit associated with the resource, rescheduling the first project so that the first project's end time is different from the first project's due date.

12. The method of claim 5, wherein determining the phase start time and the phase end time for the phase based at least on the first project's due date includes:
aligning the first project's task dependency network's end time with the first project's due date;
setting the phase end time to be equal to the latest task end time over all tasks in the first project that are associated with the phase; and
setting the phase start time to be equal to the earliest task start time over all tasks in the first project that are associated with the phase.

13. The method of claim 12, wherein the method further includes adding a capacity buffer to the phase by moving the phase end time to a later time.

14. The method of claim 1, wherein associating at least some tasks in some of the projects with the phase includes:
presenting a first task dependency network for a first project to a user;
receiving input from the user which identifies a first group of tasks in the first task dependency network that defines the phase's boundary;
identifying a second group of tasks such that each task in the second group of tasks lies on at least one path between two tasks in the first group of tasks; and
associating the first group of tasks and the second group of tasks with the phase.

15. The method of claim 1, wherein all tasks in all of the projects in the set of projects are associated with the phase.

16. The method of claim 1, wherein if a first project in the set of projects is currently executing, the first project's start time and end time are treated as being fixed.

17. The method of claim 1, further comprising:
presenting the project start times and the project end times for at least some projects in the set of projects to a user;
receiving, from the user, a new phase duration for the phase in a first project which is different from the phase duration that was used for determining the project start times and the project end times;
determining new project start times and new project end times for at least some projects in the set of projects so that the aggregate weight of the projects that are in the phase at any given time is less than or equal to a work-in-process limit associated with the phase; and
presenting the new project start times and the new project end times to the user.

18. A computer-readable storage medium storing instructions that when executed by a computer cause the computer to perform a method for scheduling multiple projects, the method comprising:
receiving a set of projects, wherein each project includes a group of tasks whose interdependencies are representable using a task dependency network, and wherein each project is associated with a due date;
associating at least some tasks in some of the projects with a phase; and
determining project start times and project end times for at least some projects in the set of projects so that the aggregate weight of the projects that are in the phase at any given time is less than or equal to a work-in-process limit associated with the phase.

19. The computer-readable storage medium of claim 18, wherein determining the project start times and the project end times for at least some projects in the set of projects includes:
scheduling a first project so that the first project's end time coincides with the first project's due date;
determining a phase start time and a phase end time for the phase in the first project based at least on the first project's due date; and
in response to detecting that the aggregate weight of the projects in the phase is greater than the work-in-process limit, rescheduling the first project so that the first project's end time is different from the first project's due date.

20. The computer-readable storage medium of claim 19, wherein the method further includes:
adding one or more resource usage amounts to one or more time buckets based at least on when the resource is expected to be used by the first project; and
in response to detecting that a time bucket's aggregate resource usage exceeds a usage limit associated with the resource, rescheduling the first project so that the first project's end time is different from the first project's due date.

21. An apparatus for scheduling multiple projects, comprising:
a receiving mechanism configured to receive a set of projects, wherein each project includes a group of tasks whose interdependencies are representable using a task dependency network, and wherein each project is associated with a due date;
an associating mechanism configured to associate at least some tasks in some of the projects with a phase; and
a determining mechanism configured to determine project start times and project end times for at least some projects in the set of projects so that the aggregate weight of the projects that are in the phase at any given time is less than or equal to a work-in-process limit associated with the phase.

22. The apparatus of claim 21, wherein the determining mechanism is configured to:
schedule a first project so that the first project's end time coincides with the first project's due date;
determine a phase start time and a phase end time for the phase in the first project based at least on the first project's due date; and
in response to detecting that the aggregate weight of the projects in the phase is greater than the work-in-process limit, reschedule the first project so that the first project's end time is different from the first project's due date.

23. The apparatus of claim 22, wherein the determining mechanism is configured to:
add one or more resource usage amounts to one or more time buckets based at least on when the resource is expected to be used by the first project; and
in response to detecting that a time bucket's aggregate resource usage exceeds a usage limit associated with the resource, reschedule the first project so that the first project's end time is different from the first project's due date.
